(19) United States
(12) Patent Application Publication
(10) Pub. No.: US 2004/0105425 A1
(43) Pub. Date: Jun. 3, 2004

(54) Modular switch system on high-speed serial bus

(76) Inventors: Heng-Chien Chen, Taipei (TW); Jui-Liang Weng, Kaohsiung (TW)

Correspondence Address: NAIPO (NORTH AMERICA INTERNATIONAL PATENT OFFICE), P.O. BOX 506, MERRIFIELD, VA, 22116, US

(21) Appl. No.: 10/307,692

(22) Filed: Dec. 2, 2002

(51) Int. Cl. H04L 12/66

(52) U.S. Cl. 370/352

(57) ABSTRACT

A modular switch system linking on a high-speed serial bus mainly relies on a host machine connector (10) to connect with independent functional modules (20) which provides different functions of a PBX switch module processor such as internal line exchange, external line exchange, voice recording and backbone support. Under such conditions, each functional module (20) becomes a node in a local network, so that these nodes can be interconnected with each other for simultaneous signal transmission. Each functional module (20) possesses a card slot (21), an interface controller (23), a microprocessor (22), and a power supply (24). In the closed network architecture, the data transfer rate and the processing speed of the system can be substantially improved. Furthermore, the system also allows for hot plug-in, expandability, and flexible configuration.

### BACKGROUND OF THE INVENTION

1. Field of the Invention

The present invention relates to a modular switch system linking on a high-speed serial bus, in particular to a telephone switch system that makes use of switch module processors in a network to achieve expandability, high transmission rate, and flexible configuration.

2. Description of Related Arts

Modern switch systems have extensively made use of the massive data processing capability of computer and networking technology to cope with the increasing demands from users. Computer and telephony integration (CTI) has created a new dimension for high-level telephone services. The standard functions provided by existing exchange equipment such as call connection, voice mail box, and automatic line switching can no longer satisfy current users in the era of broadband transmission. With the introduction of the fixed line network using broadband transmission media, private branch exchange (PBX) is now able to provide users with multi-functional telephone services. The new generation of switch processors (IPBX) has incorporated Internet functions in the service packages, including automatic call distribution (ACD), interactive voice directory (IVD), voice mail services (VMS), fax on demand (FOD), and synchronous recording.

The application of digital technology to the telephone switch system enables the new switch module processors to handle non-voice signal exchange besides the often-used voice communication. On the whole, the development of integration of computer and telephony (CTI), asynchronous transmission exchange (ATM), and other telecommunication technologies have brought about the integration of voice and data, image processing capability, and networking over the existing communication cables or fixed line networks, by providing a range of new services such as intelligent network, video conferencing, Internet telephony (IP), call center, interactive voice service, among others which have gained popularity and will continue to do so in the future.

The hardware of switch systems has been largely upgraded over the past years to cope with the addition of the integrated functions and future expansion capability. As shown in FIG. 4, a conventional switch system is constructed from a circuit board (70) employing a central processor (71) for hub control. The circuit board (70) is connected with various independent modules through a number of card slots equipped with insertion sockets for installation of internal line exchange cards (72), external line exchange cards (73) and voice recording cards (74). These card slots are basically constructed to conform to a given specification for data transfer, signal exchange and power supply. Each functional card possesses a number of data bus, address bus, control bus, and analog bus for connecting the corresponding bus on the various switch module processors.

An existing model of a switch processor with expansion capability is shown in FIG. 5, in which the system functions are controlled by the central processor (71) installed on an interface card. The signal communications between other system components are carried out through data bus, address bus, control bus, and analog bus, in the same way as the previously mentioned example.

Under the existing architecture of the PBX switch module processor, whether the circuit board (70) is embedded in the system or externally mounted on an interface card, signal communication and control operations between the central processor and the interface card are carried out through the above bus, resulting in various problems to be described below:

Limited expansion capability: Since the circuit board (70) has a certain number of card slots complying with certain specifications, the expandability is constrained by the number of card slots in the board.

Affecting operation speed: Since the bus loading will increase in proportion to the number of functional cards installed, the overall operation efficiency could be adversely affected.

Hot plug-in not allowed: It will be difficult to install or remove functional modules installed on the circuit boards (70) when the system power is in an active state.

High costs: Since adequate card slots have to be prepared in the circuit board (70), the installation procedures will become more complex as the number of interface cards increases, and so will the costs.

Fixed configuration: Since the circuit board layout is constrained by the required number of card slots, there can be little variation for the design of the external casing.

### SUMMARY OF THE INVENTION

The main object of the present invention is to provide a switch system composing of multiple switch module processors that can be connected to all other nodes through a high-speed serial bus network, and possessing the advantages of high speed processing, system expandability, hot plug-in and flexible configuration.

The switch system in accordance with the present invention comprises at least one host machine connector and a number of functional modules.

The host machine connector has an embedded control unit and a power supply unit, wherein the control unit is connected by a number of repeaters, each corresponding to a card slot on board the host machine connector, and each card slot is respectively connected to the power supply unit for receiving the operating power.

The functional modules are connected to the card slots on board the host machine connector through the high-speed serial bus, and drawing the operating power through the power bus of the card slots;

The interconnection between the above-mentioned host machine connectors and the functional modules are done by means of a high-speed serial bus, forming a closed network. This new network structure enables considerable improvement in system performance, and expandability. The new system also permits hot plug-in and easy installation and operation.

The above-mentioned closed network is in compliance with the IEEE 802.3 specifications for the Ethernet-based network.

A functional module in accordance with the invention should at least include:

a card slot used to link to the high-speed serial bus for bidirectional communication and to connect to a power supply unit;

a microprocessor, connected to specified functional circuits for processing I/O data and for exercising control functions;

an interface controller, installed between the microprocessor and the card slot, which receives output from the microprocessor and generates data packets, or receives data packets and decodes to restore the original data format for the microprocessor; and

a power supply unit, where the input is connected to the card slot for obtaining the operating voltage, and, after appropriate conversion to direct current, the power is used to supply all components in the function module.

Since each functional module is equipped with an independent microprocessor, under the above-mentioned architecture of the functional module, the system performance of the switch system can be increased in proportion to the number of functional modules installed, therefore the overall system performance having no bottlenecks is improved considerably.

The power supply unit provides DC/DC conversion for components with different voltage requirements meeting different component/circuit specifications.

The functional module provides the functions of internal line exchange, external line exchange, voice recording, wireless communication, and arithmetic processing.

The features and structure of the present invention will be more clearly understood when taken in conjunction with the accompanying drawings.

### BRIEF DESCRIPTION OF THE DRAWINGS

FIG. 1 is the system configuration of the present invention;

FIG. 2 is a block diagram of the control unit inside the switch module processor of the invention;

FIG. 3 is a block diagram of the functional module used in the invention;

FIG. 4 is the system architecture of a conventional switch processor; and

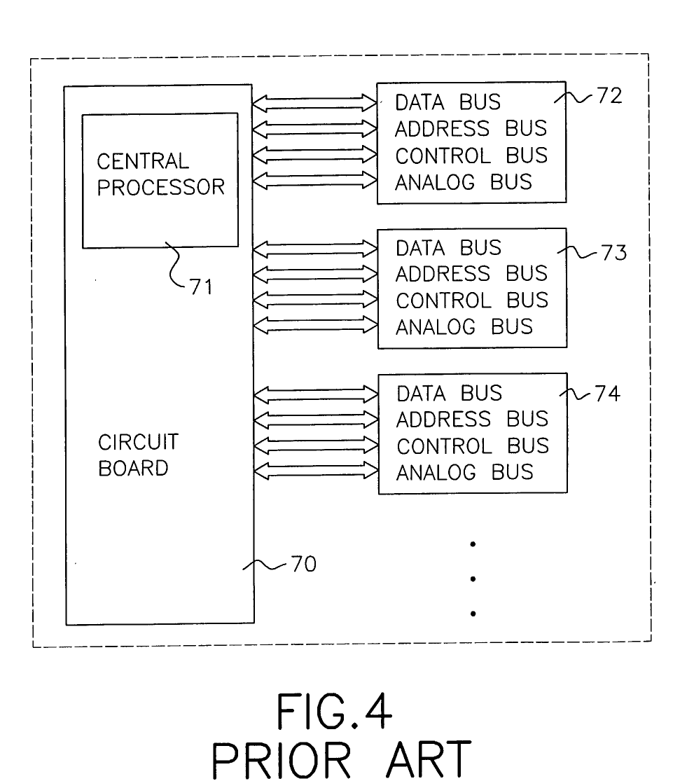

FIG. 5 is the system architecture of another conventional switch processor.

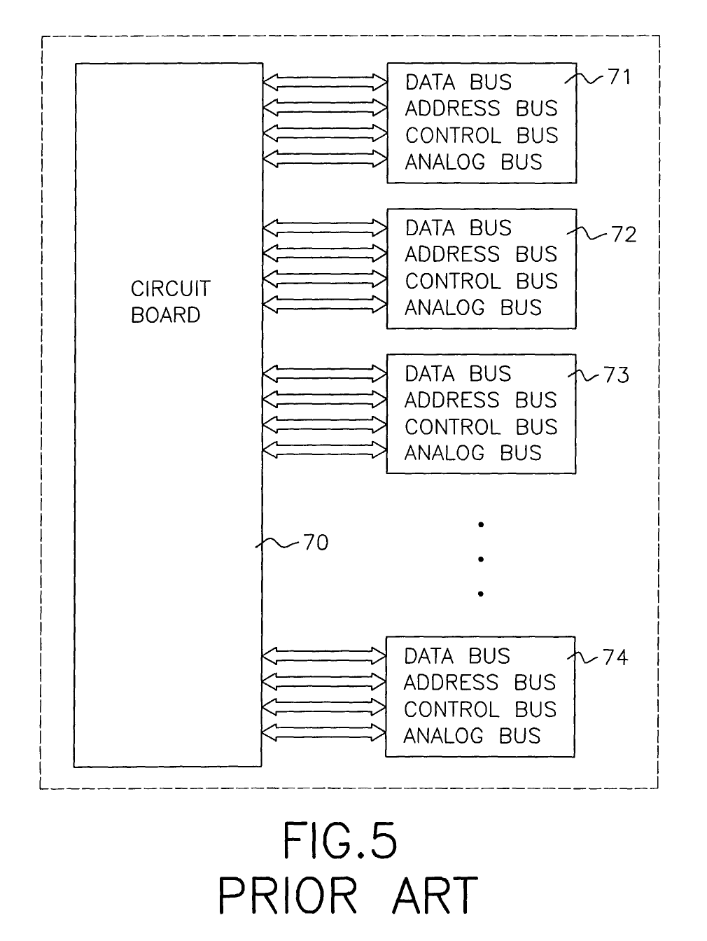

### DETAILED DESCRIPTION OF THE PREFERRED EMBODIMENT

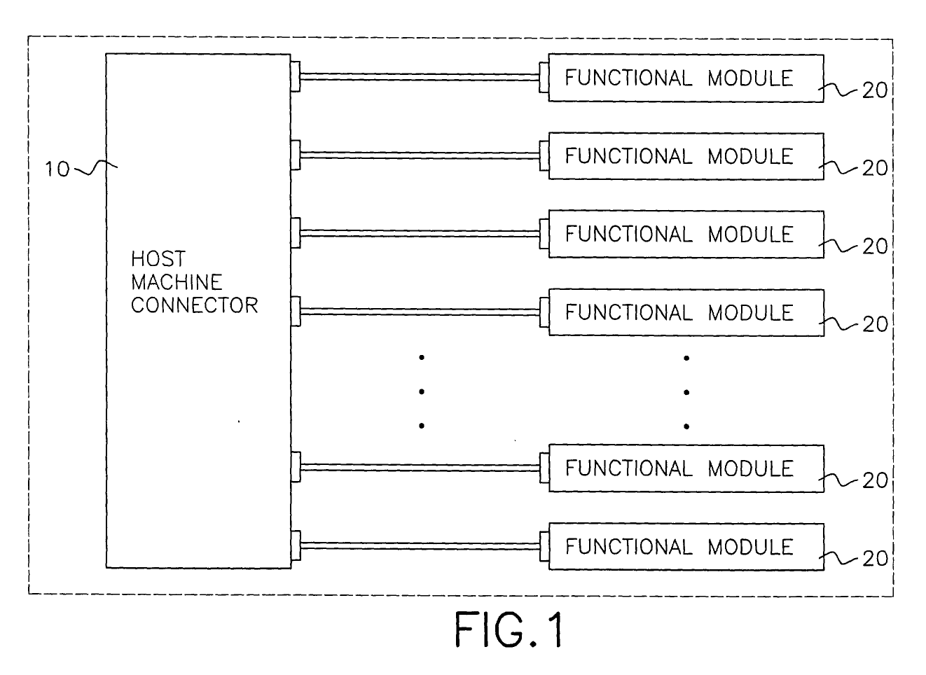

The present invention will hereinafter be described in reference to the drawings. The switch system, as shown in FIG. 1, mainly relies on individual host machine connectors (10) each connecting to a number of functional modules (20), as PBX switch module processors, over a high-speed serial bus, forming a modular switch system.

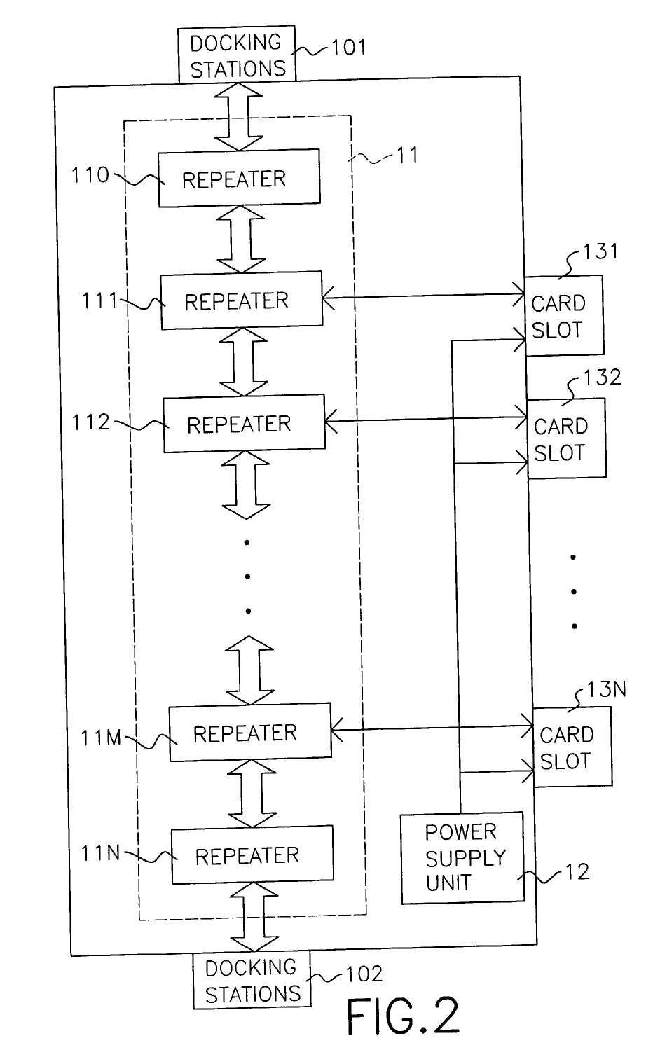

With reference to FIG. 2, the host machine connector (10) is equipped with an embedded control unit (11) and a power supply unit (12). The control unit (11) is interconnected with an unspecified number of repeaters (110˜11n), which are used for amplifying the input signals or regenerating a new set of signals for the downstream nodes. The first and last repeaters (110) (11n) on both ends of the serial bus network are respectively connected to a docking station (101) (102) for possible connections with other host machine connectors (10) and external devices. This design is in consideration of the system expansion to cope with any future needs. Each repeater (110˜110n) in the control unit (11) is respectively connected to a corresponding card slot (131˜13m). Each card slot (131˜13m) is also connected to the power supply unit (12) for receiving the operating voltage. The host machine connector (10) supplies the necessary operating power for the functional modules (20) through these card slots (131˜13m). Alternatively, the power supply could be provided by other external power units. In such case, the host machine connector (10) does not need a separate power supply unit (12), and there should be no connection between the power supply unit (12) and the card slots (131˜13m).

The above-mentioned card slots (131˜13m) are used for connection with functional modules (20) linking on a high-speed serial bus. The high-speed serial bus network, as in the current embodiment, is implemented with Ethernet technology.

Each function module (20) in conjunction with the host machine connector (10) provides one of the basic functions of a PBX switch module processor such as the central processor (CPU), automatic call distribution (ACD), interactive voice directory (IVD), voice mail service (VMS), fax on demand (FOD), synchronous recording, external line exchange, wireless communication, and backbone support. The functional modules (20) are connected with the host machine connector (10) through the corresponding card slot (131˜13m) linking on a high-speed serial bus. Each functional module (20) also receives the necessary operating power through the card slot (131˜13m).

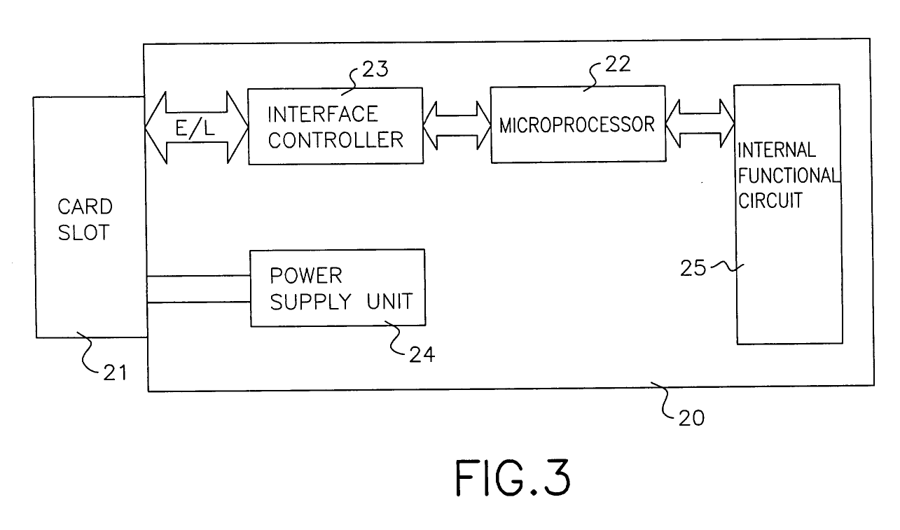

With reference to FIG. 3, the configuration of each functional module (20) includes at least a card slot (21), a microprocessor (22), an interface controller (23), and a power supply unit (24).

The card slot (21) linking on a high-speed serial bus is used for bidirectional data communication and drawing the necessary operating power.

The microprocessor (22) is connected to functional circuits for processing I/O data and for exercising controlling functions.

The interface controller (23) is connected between the microprocessor (22) and the card slot (21), which receives output from the microprocessor (22) and generates data packets; or it receives data packets and decodes to restore the original data format for processing by the microprocessor (22.

The power supply unit (24) has its input connected to the card slot (21) for obtaining the operating power, and, after appropriate conversion to the direct current, the output power is used to supply all components in the function module (20). The power supply unit (24) also provides DC/DC conversion for components requiring direct current with different voltages in order to satisfy the power specifications for all components and circuits installed on the host machine connector (10).

It becomes apparent that the above-mentioned functional modules (20), representing individual nodes, are connected to the host machine connector (10), representing a hub, through high-speed serial bus, thus forming a closed network, in which one of the functional modules (20) is responsible for the controller function, whilst other functional modules (20) can exchange control signals and data packets linking on a high-speed serial bus simultaneously. The closed network forms the basic structure of the new communication switch system, whereby the system processing and transmission speed can be improved considerably, fully making use of distributed processing capability in various functional modules (20) of the closed network.

The closed system of functional modules (20) can also help improve the operating efficiency of switch system, with no bottlenecks in the data transmission path. Since each functional module (20) is equipped with an independent microprocessor (22), the overall system performance of the switch system will be increased in proportion to the number of functional modules (20) installed.

The new switch system linking on a high-speed serial bus is advantageous as compared with the conventional switch system in that:

the system is implemented with the currently available Ethernet technology;

the system allows for expansion to cope with future needs;

the system enables hot plug-in for additional installation or maintenance needs;

the system is in compliance with the IEEE 802.3 communication protocol supporting high-speed serial bus; and

the system supports flexible configuration by reducing the number of card slots on board, enabling more variation in the casing design.

The foregoing description of the preferred embodiments of the present invention is intended to be illustrative only and, under no circumstances, should the scope of the present invention be so restricted.

What is claimed is:

1. A modular switch system linking on a high-speed serial bus is based on a host machine connector (10), which is simultaneously connected to a number of independent functional modules (20), as PBX switch module processors, through card slots (131˜13m) on board, wherein connections with functional modules (20) are supported by same communication protocol for both voice and data communication in both directions.

2. The modular switch system as claimed in claim 1, wherein each host machine connector (10) of the switch system has an embedded control unit (11) being connected by a number of repeaters (110˜11n), and each repeater (110˜11n) is connected to a corresponding card slot (131˜13m) for connection with the functional modules (20) and other external devices.

3. The modular switch system as claimed in claim 2, wherein the host machine connector (10) also has a power supply unit (12) being connected to a corresponding card slot (131˜13m) for receiving the operating power.

4. The modular switch system as claimed in claim 1, wherein each functional module (20) at least includes:
a card slot (21) to link with a high-speed serial bus for bidirectional communication and to connect to a power source;
a microprocessor (22) to connect to functional circuit for processing I/O data and for exercising control functions;
an interface controller (23), connected between the microprocessor (22) and the card slot (21), which receives output from the microprocessor (22) and generates data packets; or else, it receives data packets and decodes to restore the original data format for the microprocessor (22); and
a power supply unit (24), where the input is connected to the card slot (21) for obtaining the operating power, which after appropriate conversion to the direct current is used to supply various components in the function module (20).

5. The modular switch system as claimed in claim 4, wherein each functional module (20) provides the basic functions of a PBX switch module processor such as a central processor (CPU), automatic call distribution (ACD), interactive voice directory (IVD), voice mail service (VMS), fax on demand (FOD), synchronous recording, wireless communication, and backbone support.

6. The modular switch system as claimed in claim 4, wherein the power supply unit (24) provides DC/DC conversion for components requiring direct current with different voltages.

7. The modular switch system as claimed in claim 1, wherein the switch system is in compliance with IEEE 802.3 communication protocol forming a closed network on a high-speed serial bus.

8. The modular switch system as claimed in claim 2, wherein the switch system is in compliance with IEEE 802.3 communication protocol forming a closed network on a high-speed serial bus.

9. The modular switch system as claimed in claim 3, wherein the switch system is in compliance with IEEE 802.3 communication protocol forming a closed network on a high-speed serial bus.

10. The modular switch system as claimed in claim 4, wherein the switch system is in compliance with IEEE 802.3 communication protocol forming a closed network on a high-speed serial bus.

11. The modular switch system as claimed in claim 5, wherein the switch system is in compliance with IEEE 802.3 communication protocol forming a closed network on a high-speed serial bus.

12. The modular switch system claimed in claim 6, wherein the switch system is in compliance with IEEE 802.3 communication protocol forming a closed network on a high-speed serial bus.
